(19) United States
(12) Patent Application Publication
(10) Pub. No.: US 2011/0163167 A1
(43) Pub. Date: Jul. 7, 2011

(54) CONTACTLESS CARD WITH SECURITY LOGO

(75) Inventors: Olivier Artigue, Trets (FR); Stéphane Semori, Hyeres (FR); Deborah Teboul, Vitrolles (FR); Cécile Sicot, Rousset (FR)

(73) Assignee: SMART PACKAGING SOLUTIONS (SPS), Rousset (FR)

(21) Appl. No.: 13/000,196

(22) PCT Filed: Jun. 21, 2009
(86) PCT No.: PCT/FR2009/000747

§ 371 Date: Mar. 24, 2011

(30) Foreign Application Priority Data
Jun. 20, 2008 (FR) 08/03472

(51) Int. Cl. G06K 19/077; G03H 1/02

(52) U.S. Cl. 235/488; 235/492; 359/2

(57) ABSTRACT

The invention relates to a contactless smart card that comprises a card body and an electronic module provided with an electronic chip connected to the terminals of an antenna, the electronic module being arranged in a recess formed in the card body, wherein the exposed surface of the electronic module comprises at least one graphic security element capable of protecting said electronic module and the contactless card against attempts at fraud.

The invention relates to contactless smart cards, more particularly electronic identification cards or passports including a security logo.

The invention does not depend on the size of the chip card and may apply to conventional chip cards as well as to other secured documents provided with a contactless card electronic module, so that, in order to simplify the description, the same word “contactless smart card” will refer to chip cards in the conventional format (according to standard ISO 7816-1) as well as to security documents having another format but also being provided with an electronic module of the same type as those usually used in contactless smart cards.

### STATE OF THE ART

Several types of cards or secured documents including an electronic chip are already known in the state of the art.

Then, identification cards in the format of a contact chip card are known, wherein the electronic module is “embedded”, i.e. fixed in a recess of the card body, so that the electric contacts of the module remain accessible at the surface to enable the connection with a contact card reader. This type of identification card raises the problem of a possible access to the contacts, or even of the pure and simple replacement of the electronic module for identity fraud purposes.

Of course, it would be advisable to provide the contact identification chip cards with a security graphic covering the upper face of the card and making it possible to detect cases of fraud, but such a security graphic cannot be easily provided in the area of the electronic module since the conductivity of the contacts might be affected.

In order to partially solve this problem, document DE-196 25 466 C1 described a contact chip card, the contacts of which are also provided with a graphic, more particularly having a specific colour different from the usual gold or silver colour. For this purpose, the contacts are coated with a metallic scattering layer containing aluminium-based colour particles. However, the contacts remain electronically accessible, which gives way to acts of fraud through the attack of the chip circuit on the contacts of the chip card. In addition, the contacts and the module also remain physically accessible, which makes it possible to consider removing or even replacing the electronic module.

A contact chip card is also known from document U.S. Pat. No. 6,259,035 B1, wherein the electronic module and the metallic contacts are made as discrete as possible, as for their aspect, by colouring the contacts themselves, and the graphic on the module surface is an extension of the current body graphic. Of course, this method is reserved to contact cards and cannot be applied to contactless cards such as those used for the production of contactless identification cards.

A reverse approach has been disclosed in document U.S. Pat. No. 5,552,574 which describes, on the contrary, how the surface of the contacts of a contact chip card can be provided with a security engraving executed with a laser beam.

The results of the above-mentioned examples is that the problem of security markings was solved for contact cards, either by guilloches or other graphics executed on the card body or by the graphic alteration of the metallic contacts of the module in the form of colours or laser engraving directly executed on the contacts.

The utilisation of contactless smart cards in security or identification applications is also known and such cards tend to spread in such applications, because of they can be used more easily.

In contactless cards, electronics including a chip connected to an antenna is most often provided separately in the form of an insert which is then laminated between external protection layers. Electronics is then protected against a direct access by contact, but separating the various layers and fraudulently replacing the insert or even retrieving it in order to produce a fraudulent contactless identification card however remains possible.

Another drawback of contactless cards produced from an insert interposed between external protection layers lies in the production method thereof. As a matter of fact, the insert is the most expensive part of the card and it can be damaged during the lamination with the external layers, which causes the production yield of such type of cards to drop and the unit price to increase.

It would then be more advisable to use more reliable production methods with a higher yield, such as the conventional embedding method for contact cards, which consists in positioning a contact module in a recess of the card. But as previously seen, the method as such is not very safe, since the thus produced cards are particularly exposed to fraud which consists in tearing off the card module, which is particularly not recommended for cards or documents intended for identity check applications.

In addition, some cards are produced with a double communication interface technology, and include both contactless electronics embedded in the card body and further provided with contacts for the communication with a contact card reader. This type of card potentially cumulates the security flaws of both types of cards described here-above.

### PURPOSE OF THE INVENTION

One object of the present invention is thus to provide a contactless card structure capable of remedying the above-mentioned drawbacks of the chip identification cards or identification documents.

More particularly, one object of the present invention is to provide a contactless smart card intended for applications of the identification check type which can be easily produced with high yields comparable with the production yields of contact cards, while being compatible with security graphics such as security logos or holograms.

Another object of the invention is to provide a chip card having a very high reliability and a very long service life of the order of five to ten years, while enabling a high production yield and a low cost like simple contact-operated cards.

For this purpose, the object of the invention is a contactless smart card that comprises a card body and a contactless-operated electronic module provided with an electronic chip connected to the terminals of an antenna, the module being arranged in a recess formed in the card body, characterised in that the exposed part of the module includes a graphic security element capable of protecting the electronic module and the contactless card against attempts at fraud.

According to a very simple basic embodiment, the graphic security element is simply composed of a graphic pattern provided on the exposed surface of the contactless electronic module.

This graphic pattern is composed of areas having an extra thickness and depressed areas with respect to the surface of the module and/or areas having a colour different from the rest of the electronic module surface. This graphic pattern can be obtained differently, more particularly through screen-printing or chemical etching, as for the production of metallic contacts provided in a known way for modules for contact cards.

In a more elaborate alternative embodiment of the invention, having an increased security and resistance with respect to physical attacks against the module, the graphic security element is covered by at least one transparent protection layer, more particularly made of polycarbonate, placed above the card body so as to coat the exposed face of the contactless electronic module and the graphic security pattern thereof.

In order to still increase the security of the product and the resistance thereof to fraud and infringement, the transparent or translucent protection layer includes, on one of the faces thereof or in the thickness thereof, a second graphic security element which is complementary to the graphic security element of the electronic module surface, so as to form therewith a composite security element through the superimposition of both separate security elements.

Then, the invention provides that both graphic security elements can be two distinct and complementary parts of one image or one logo, so that the exact superimposition of both graphic security elements only makes it possible to recreate the complete image or logo.

Thus, the elimination of the upper protection layer would clearly suppress the second graphic security element, which would be immediately visible, since the logo or the equivalent would no longer be complete.

In one interesting alternative solution of such an embodiment, the second graphic element is composed of a hologram having a pattern complementary to the security graphic on the surface of the electronic module, so that the superimposition of the security graphic and of the hologram shows a tamper-proof security logo.

Advantageously, the surface of the hologram, or more generally of at least one of the graphic elements, is larger than the exposed surface of the module and is joined to the surface of the module, so that a fraudulent retrieval of one of the graphic elements is more easily visible.

In order to still increase the resistance or the highlighting of physical attacks against the contactless smart card, the transparent protection layer is extended beyond the upper surface of the card and is provided as a layer of encapsulation material surrounding the card body assembly on the whole surface thereof.

Of course, the hologram technique is not reserved to the transparent protection layer or to the encapsulation layer, but the graphic security element of the surface of the electronic module can also or independently be composed of a hologram showing a security pattern and positioned above the exposed face of the module, so that the access to the modules requires the destruction of the hologram.

The above-mentioned alternative solutions can be provided whatever the contactless communication structure of the card, i.e. for example the communication antenna can be directly positioned on the electronic module or in the card body and it can also be complemented by a second antenna used as an electromagnetic flux amplifier with respect to the first antenna.

Then, in a first alternative solution, the card body includes several layers of material, plastic material or even paper, and the antenna is provided between two adjacent layers of the card body and it includes contact pads arranged at the bottom of the recess of the card body and connected to connection terminals of the electronic module.

According to another alternative solution, the antenna is provided on the electronic module itself and is connected to the electronic chip thereof, so that the module coated with the graphic security element thereof can simply be reported and fixed into the recess of the card body.

But the card may also include a second antenna provided in the card body and positioned opposite the module antenna, so as to amplify the electromagnetic flux detected by the module antenna.

Another object of the invention is also to provide a contactless-operated electronic module adapted to be mounted on a contactless smart card and provided with graphic security means arranged on the exposed surface thereof, so as to remain visible after the embedding of the module in the card body, such graphic security means being more particularly obtained by differences in the level, differences in the colours of the exposed face and/or the insertion of a hologram.

Of course, the invention extends to every chip card including a card body and an innovative module such as described above.

Other characteristics and advantages of the invention will appear upon reading the detailed description and the appended drawings wherein:

FIG. 1 shows a perspective cross-sectional view of a contactless smart card provided with an electronic module, the exposed surface of which includes a graphic security element according to the invention;

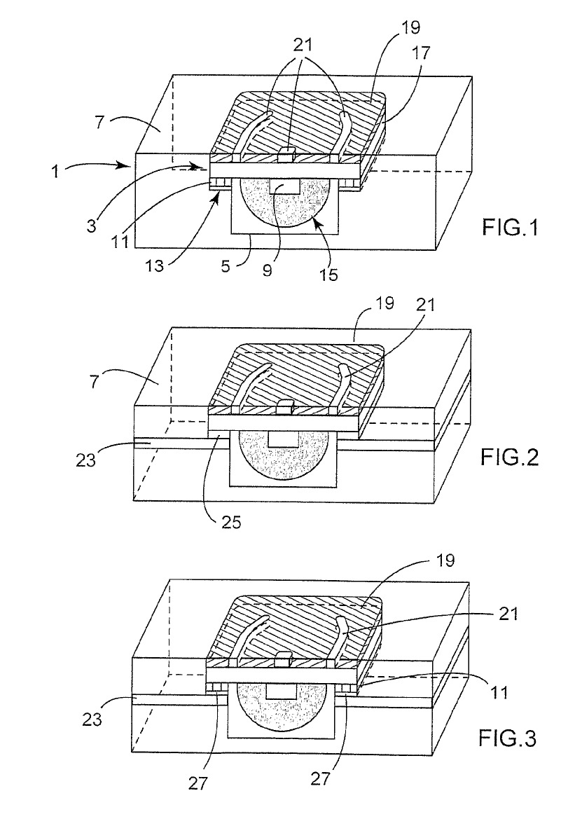

FIG. 2 shows a view similar to that of FIG. 1, but wherein the chip card includes a large antenna integrated in the card body and connected to electric contacts of the electronic module;

FIG. 3 shows a view similar to that of FIG. 2, but wherein the second antenna is not connected to the chip of the electronic module;

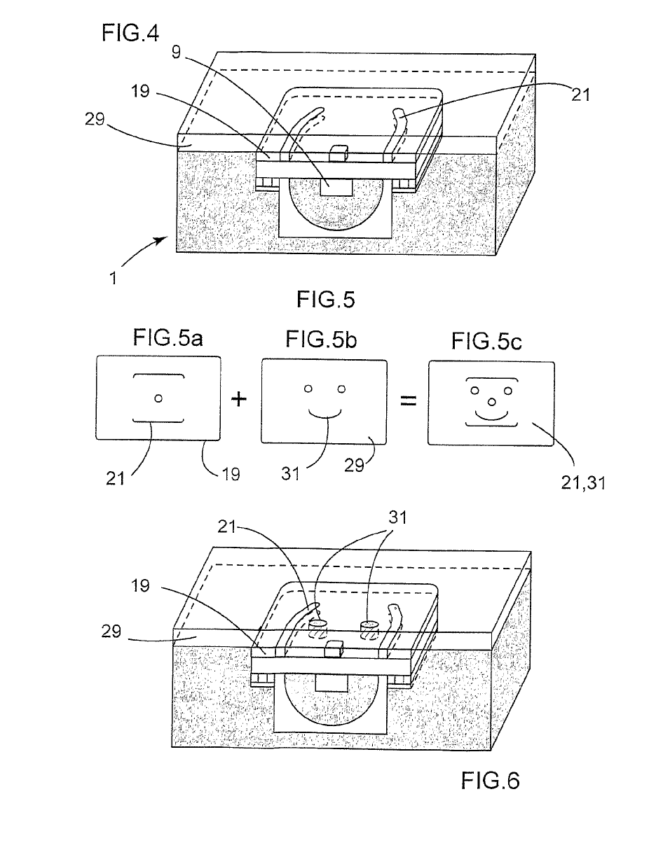

FIG. 4 shows a view similar to those of FIGS. 1 to 3, but wherein the graphic security element of the electronic module surface is coated with a transparent protection layer;

FIG. 5 illustrates the elements of an electronic module capable of creating a security image through the superimposition of layers;

FIG. 6 shows a perspective and cross-sectional of the superimposition of layers according to FIG. 5c, wherein the transparent protection layer includes a second graphic security element complementary to that of the surface of the electronic module;

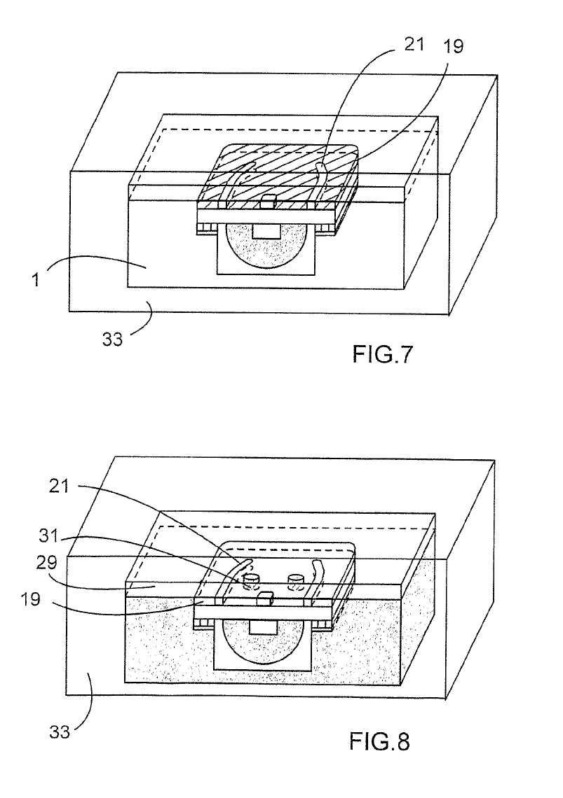

FIG. 7 shows a view similar to those of FIGS. 1 to 3, wherein a transparent encapsulation layer covers the whole chip card;

FIG. 8 shows a view similar to that of FIG. 6, wherein the transparent encapsulation layer covers the whole chip card.

Reference is made to FIG. 1. An area of the contactless smart card 1 is shown in perspective and in cross-section, close to the electronic module 3 of the chip card, it being understood that the area shown can also correspond to a part of a secured document having a format different from that of a chip card, such as for example an identification card or an electronic passport and including a contactless-operated electronic module.

The electronic module 3 is knowingly mounted in a recess 5 of the card body 7. A chip 9 fixed on the face of the module opposite the visible face thereof is schematically shown. The chip 9 is electrically connected to the terminals of an antenna 11 provided on the module and intended to provide a contactless communication with an external reader, not shown. The electronic module 3 is fixed in the recess 5 using an adhesive 13. The electronic card 9 is protected by a droplet of encapsulation resin 15. During the assembling of the chip card, the module is reported opposite the recess 5 arranged in the card body. The module is fixed in the recess as shown in FIG. 1, with the windings of the antenna 11 contacting the adhesive 13. Then, a step of pressing on the upper face of the module follows to provide a high quality sticking of the module in the recess.

The chip 9 and the windings of the antenna 11 are fixed on a support layer 17 made of dielectric material which is in turn covered by the visible face 19 of the electronic module 3 when the latter is positioned in the recess 5 of the card body.

According to the invention, such exposed layer 19, the surface of which is flush with the surface of the card body, includes one or several graphic security element or elements 21 capable of protecting the electronic module and the contactless card against attempts of fraud. For this purpose, this exposed layer 19, which is more particularly made of metal as the well-known contacts of contactless smart cards includes graphic patterns provided through various techniques known per se, such as etching or printing, and capable of identifying the identification chip card or the holder thereof, and in any case in making a fraudulent copy of the identification card more difficult.

Then, whereas in the case of contact cards the surface of the module includes electric contacts having more or less uniform and standardised shape and size, the contactless card according to the invention includes graphic elements provided with similar technologies known per se, but with different shape and function, i.e. the security marking of contactless card modules. It should be noted that such a marking is not required itself to provide the communication function of the chip card with an external reader, but it provides, thanks to the difficult copying thereof, a new security function in the application thereof to a contactless card.

Of course, the size and the shape of the graphic security elements 21 can be of any kind as well as the embodiment thereof, in so far as they fulfil the requested security purpose.

In so far as the graphic security elements 21 do not interfere with the contactless communication function of the chip card, such communication structure can have various embodiments.

Then, an alternative embodiment is shown in FIG. 2 wherein, in order to increase the communication range of the contactless smart card, a larger antenna 23 than the antenna 11 in FIG. 1 has been provided between layers of the card body 7 instead of the antenna 11 of the module, and such an antenna 23 is connected to appropriate terminals of the electronic chip through connecting pads 25.

Another alternative embodiment is shown in FIG. 3, wherein the second antenna 27 is electrically isolated from the antenna 11 of the module by means of an isolating layer 27. Then, the antenna 23 is liable to resonate with the antenna 11 of the module and is then used as an electromagnetic amplifier with respect to the signals which must be exchanged between the electronic chip 9 and an external contactless reader.

According to an even more interesting alternative of the invention, diagrammatically shown in FIG. 4, the exposed layer 19 of the electronic module includes first graphic security elements 21, and such exposed layer 19 is covered by at least one transparent or at least translucent protection layer 29, arranged above the card body so as to coat the exposed face 19 of the electronic module and the first graphic security elements 21 thereof. A material sufficiently resistant to prevent the separation thereof from the rest of the card and having a long enough life to provide the service life requested by the identification card applications, typically 5 to 10 years, will be chosen for the protection layer 29. A possible choice will be to provide a protection layer made of polycarbonate or an equivalent.

As schematically shown in FIG. 5b, the protection layer 29 preferably includes two second graphic security elements 31, ideally complementary to the first graphic security elements 21 arranged on the exposed face 19 of the module, so that the superimposition thereof forms a composite image or a complete security logo 21, 31 obtained through the superimposition of the images of the first and second graphic security elements 21, 31.

Thus, both graphic security elements 21, 31 are ideally two distinct parts of the same composite image or of a logo, so that the superimposition of both graphics security elements only makes it possible to recreate the complete image or logo. On the contrary, the removal or the damaging of the upper protection layer would immediately reveal the fact that the contactless smart card has been modified and can no longer be accepted by the authorities managing the card application.

Of course, in order to prevent accidental damaging of the second graphic security elements 31, the latter are preferably provided either on the face of the layer 29 which is in close contact with the external face of the layer 19, or in the thickness of the layer 29, as shown in perspective in FIG. 6.

In an advantageous alternate embodiment of the invention, said first and/or second graphic elements 21, 31 are composed of holograms. Then, the hologram shows a pattern complementary to the security graphic or the hologram 21 of the surface of the electronic module, so that the superimposition of the security graphic and of the hologram or both holograms shows a tamper-proof security logo.

The surface of at least one of the graphic elements 21, 31 is preferably larger than the exposed surface 19 of the module and is joined to the surface of the module, so that a fraudulent retrieval of one of the graphic elements 21, 31 is more easily visible.

As shown in FIG. 7, the transparent protection layer 19 provided with the graphic security elements 21 can go beyond the surface of chip card and can be provided as a layer of an encapsulation material 33 surrounding the card body assembly on the whole surface thereof which makes any separation of the layers of the chip card impossible without causing visible damage.

Of course, such an encapsulation layer 33 can also be considered in the case where the card includes an additional protection layer 29 provided with second graphic security means 31, as shown in FIG. 8.

### ADVANTAGES

The invention reaches the desired aims and provides a contactless electronic module and a chip card using such a module including graphic security elements making it possible to substantially increase the resistance to physical attacks of contactless cards and more particularly, but not exclusively, for the holder's identity check applications, such as the contactless identification cards and the contactless passports.

In fact, the graphic security elements 21 are provided on the surface of the electronic module and such module becomes particularly simple to use for industrialists which are not specialised in contactless cards. As a matter of fact, it is sufficient to report the contactless module already secured in the recess of a card body using extremely conventional embedding methods and already known in the field of contact cards, which results in a significant gain in production rates, a significant increase in production yields and reliability and accordingly a reduction in the unit cost.

Then, it becomes possible to apply such a technology of production of modules with a security logo to obtain chip cards intended for extremely rigorous applications or applications having a very long service life, such as for example the application to identification cards or electronic passports for which government organisations generally require guaranteed behaviour and correct operation for ten years.

1. A contactless smart card that comprises a card body and an electronic module provided with an electronic chip connected to the terminals of an antenna, the electronic module being arranged in a recess formed in the card body, wherein the exposed surface of the electronic module comprises at least one graphic security element capable of protecting said electronic module and the contactless card against attempts at fraud.

2. A chip card according to claim 1, wherein the graphic security element is composed of a graphic pattern executed on the exposed surface of the contactless electronic module, said graphic pattern being composed of areas having an extra thickness and depressed areas with respect to said surface, and/or of areas having a colour different from the rest of the surface of the electronic module.

3. A chip card according to claim 1, wherein the graphic security element is covered by at least one transparent protection layer arranged above the card body so as to coat and protect the exposed face of the electronic module.

4. A chip card according to claim 3, wherein said transparent protection layer includes at least a second graphic security element, which is complementary to the graphic security element of the exposed surface of the electronic module so as to form therewith a composite security element by superimposition of both security elements.

5. A chip card according to claim 4, wherein the two graphic security elements are two distinct parts of an image or a logo, so that the superimposition of both graphic security elements makes it possible to recreate the complete image or logo.

6. A chip card according to claim 5, wherein the surface of at least one of the graphic elements is larger than the exposed surface of the module and is joined to the surface of the module, so as to more easily view a fraudulent retrieval of one of the graphic elements.

7. A chip card according to claim 6, wherein said first and/or second graphic elements are composed of holograms and have complementary patterns, so that the superimposition of the security graphic and of the hologram or the superimposition of both holograms shows a tamper-proof security logo.

8. A chip card according to claim 3, wherein the transparent protection layer is in the form of a layer of an encapsulation material surrounding the card body assembly on the whole surface thereof.

9. A chip card according to claim 1, wherein the card body includes several layers of material, and wherein the communication antenna is provided between two adjacent layers of the card body and includes contact pads arranged at the bottom of the recess of the card body and connected to connection terminals of the electronic module.

10. A chip card according to claim 1, wherein the communication antenna is provided on the electronic module itself and is connected to the electronic chip thereof, so that the module coated with the graphic security element thereof can simply be reported and fixed into the recess of the card body.

11. A chip card according to claim 10, further including a second antenna provided in the card body and arranged opposite the antenna of the module, so as to amplify the electromagnetic flux detected by the antenna of the module.

12. An contactless-operated electronic module for the production of a contactless smart card by the insertion of the module into a recess arranged in the body of said chip card, wherein it includes on the apparent face thereof, after the insertion, at least one graphic security element, obtained by differences in the level, differences in the colours of the exposed face, and/or by affixing an hologram.
